(19) United States
(12) Patent Application Publication
(10) Pub. No.: US 2006/0010378 A1
(43) Pub. Date: Jan. 12, 2006

(54) Reader-specific display of text

(76) Inventor: Nobuyoshi Mori, Lorsch (JP)

Correspondence Address: FISH & RICHARDSON, P.C., PO BOX 1022, MINNEAPOLIS, MN, 55440-1022, US

(21) Appl. No.: 10/888,344

(22) Filed: Jul. 9, 2004

(51) Int. Cl. G06F 15/00

(52) U.S. Cl. 715/531; 715/512; 715/513

(57) ABSTRACT

Methods and apparatus, including computer program products, implementing techniques for reader-specific display of text. The techniques include receiving digital text data comprising base text and annotation text, receiving as input user information about a reader, customizing digital text data according to the user information about the reader, and displaying the customized digital text data. The annotation text includes one or more annotation text elements. The base text includes one or more base text elements. The digital text data associates each annotation text element with a base text element. The user information can include the reader's reading level and reading preferences. Customizing digital text data according to the user information about the reader includes mapping the user's reading level to one of a plurality of character difficulty tables that group the base text elements according to their difficulty level, each character difficulty table corresponding to a particular reading level.

### BACKGROUND

The present invention relates to data processing by digital computer, and more particularly to displaying text.

Text is sometimes displayed or printed with annotations. This is common in East Asian languages, where annotations are printed in a smaller font next to the main text (which text will be referred to as base text). Such annotations are commonly referred to as ruby text, from the name of the small size type traditionally used to print it.

Ruby text is commonly used in East Asian texts. For example, Japanese text characters (kanji) are often displayed with phonetics (kana) to help readers recognize the kanji. The kana is displayed as ruby text alongside the kanji. Ruby text is also referred to in Japanese as furigana. Furigana are commonly used in books for young readers. Books targeted at more advanced readers will include furigana only with the more difficult kanji.

Which furigana will be displayed and with respect to which kanji is a decision typically made by the text publisher, in advance of publication. In one interactive system, however, the text is initially displayed with no furigana visible; but a user can select specific kanji in the display, and the system then displays the furigana for the selected kanji.

### SUMMARY OF THE INVENTION

The present invention provides methods and apparatus, including computer program products, implementing techniques for displaying text.

In one aspect, the techniques include receiving digital text data comprising base text and annotation text, receiving as input user information about a reader, customizing digital text data according to the user information about the reader, and displaying the customized digital text data. The annotation text includes one or more annotation text elements. The base text includes one or more base text elements. The digital text data associates each annotation text element with a base text element.

Implementations of the invention can include one or more of the following features:

The user information includes a reading level. Customizing digital text data according to the user information about the reader includes using the reading level to determine for which base text elements to display annotation text elements and displaying the customized digital text data includes displaying annotation text elements as ruby text for a first group of base text elements, and not displaying annotation elements for a second group of base text elements.

Customizing digital text data according to the user information about the reader includes mapping the user's reading level to one of a plurality of character difficulty tables that group the base text elements according to their difficulty level, each character difficulty table corresponding to a particular reading level.

The user information includes a reading level and a reading preference. The received digital text data further includes substitute text elements for one or more of the base text elements. Customizing digital text data according to the user information about the reader includes using the reading level and the reading preference to determine for which base text elements to display annotation text elements and for which base text elements to display substitute text elements. Displaying the customized digital text data includes displaying annotation text elements as ruby text for a first group of base text elements, not displaying annotation text elements for a second group of base text elements; and displaying substitute annotation text elements in place of the base text elements for a third group of base text elements.

The user information includes a reading preference. The annotation text elements include elements that indicate pronunciation of base text elements and elements that indicate meaning of base text elements. Customizing digital text data for display according to the user information includes using the reading preference to determine whether to display the elements that indicate pronunciation or the elements that indicate meaning or both.

The user information is received as part of a request from the reader requesting that the text be displayed. The user information is received from stored information about the reader.

The digital text data is part of a web page or a PDF (portable document format) document. Displaying the customized digital text data includes rebuilding the web page or PDF document. Displaying the customized digital text data includes displaying the customized digital text data without rebuilding the web page or PDF document.

The invention can be implemented to realize one or more of the following advantages:

Readers can customize the display of the text to suit their personal needs and preferences rather than be limited by the decision made by a text publisher, whose decision may or may not be suitable for a particular reader. The customization requires minimal (if any) input from the reader.

The customizable display heightens the availability of the text to readers of different reading levels and promotes the learning process for readers desiring to improve their reading ability. Readers can more easily learn new characters and can read characters faster.

One implementation of the invention provides all of the above advantages.

Details of one or more implementations of the invention are set forth in the accompanying drawings and in the description below. Further features, aspects, and advantages of the invention will become apparent from the description, the drawings, and the claims.

### BRIEF DESCRIPTION OF THE DRAWINGS

FIG. 1A is a block diagram of a system in accordance with the invention.

FIG. 1B is a flow diagram of a method in accordance with the invention.

FIG. 2 is an example of text that includes annotation text.

FIG. 3 is a block diagram of one implementation of the system.

FIG. 4 is an example of Japanese text that includes annotation text indicating phonetics, where the annotation text is displayed as ruby text.

FIG. 5 is a block diagram of a web-based implementation of the system.

FIG. 6 is a block diagram of a PDF-based implementation of the system.

Like reference numbers and designations in the various drawings indicate like elements.

### DETAILED DESCRIPTION

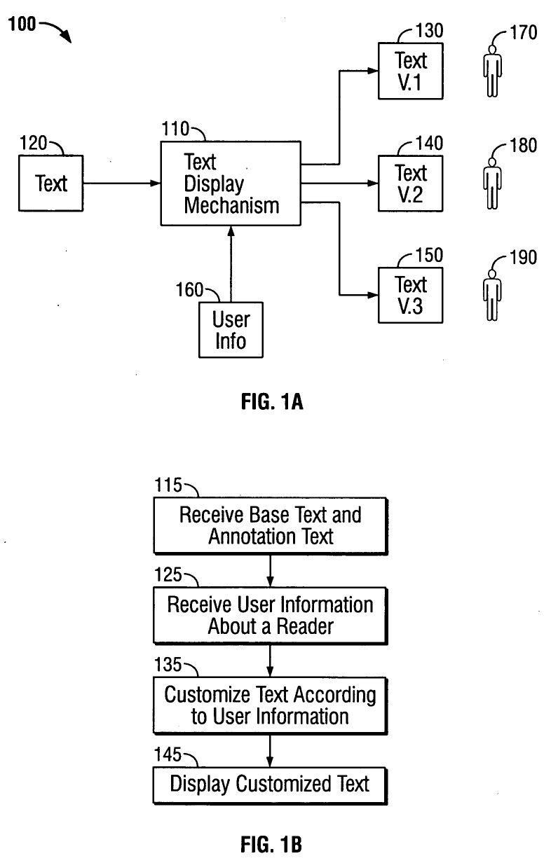

As illustrated in FIGS. 1A and 1B, a system 100 in accordance with the invention includes a text display mechanism 110 for displaying or printing a text 120. The text display mechanism 10 can be incorporated into a variety of text display systems including, but not limited to, text viewers, for example, Adobe Acrobat®, available from Adobe Systems of San Jose, Calif., and web browsers, for example, Internet Explorer®, available from Microsoft Corporation of Redmond, Wash.

During system operation, the text display mechanism 110 receives the text 120 to be displayed for view by a reader (step 115). The text 120 includes base text and annotation text associated with the base text.

The text display mechanism 110 also receives user information 160 about the reader (step 125). The user information 160 can include a variety of information about the reader, including the reader's reading level and reading preferences. The system can receive this user information 160 directly from the reader, for example as part of a user request requesting that the text 120 be displayed. Alternatively, the user information 160 can be retrieved from information stored in the system 100, for example, a stored user profile for the reader.

Before displaying the text 120 for view by a reader, the text display mechanism 110 customizes the presentation of the text 120 according to the user information 160 (step 135). This allows the text display mechanism 110 to display different presentations 130, 140, 150 of the text 120 for different readers 170, 180, 190. The text display mechanism 110 uses the user information 160 for each reader to determine how to customize each presentation. In one implementation, described further below, the text display mechanism 110 uses the user information 160 to determine which annotation text will be displayed and with respect to which base text.

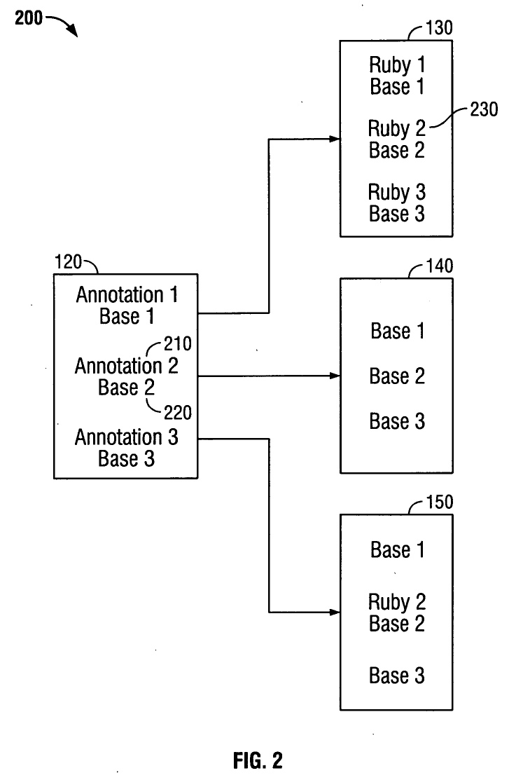

The text display mechanism 110 then displays the customized text for the reader (step 145). In the display of the customized text, the entire text as customized is immediately visible without further user intervention. That is, it is not necessary for the reader to select portions of the text in order to see the annotation text for those portions. In one implementation, illustrated in FIG. 2, the annotation text 210 associated with particular base text 220 is displayed as ruby text 230.

Customization Based on Reading Level

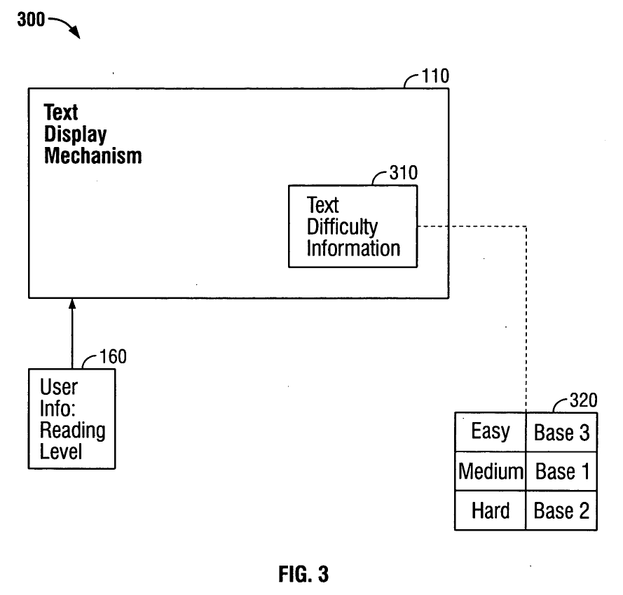

In one implementation, shown in FIG. 3, the customization is based on the reader's reading level. In this implementation, the text display mechanism 110 has access to text difficulty information 310 that groups base text elements (e.g., characters or words) according to their difficulty level. An example of text difficulty information 310 is the text difficulty table 320, which is described in more detail below. The text difficulty information 310 can be standardized information or, alternatively, it can be customized to a particular reader. The text difficulty information 310 can be retrieved from a stored location within the system, or received from the reader.

The text display mechanism 110 uses the text difficulty information 310 and the reading level information 160 to customize the presentation of the text to suit the reader. As shown in FIG. 2, for a beginning reader, the text display mechanism 110 displays the fully annotated presentation 130. For an advanced reader, the text display mechanism 110 displays the presentation 140 with no annotations, and for an intermediate reader, the text display mechanism 110 displays the partially annotated presentation 150. In the partially annotated presentation 150, only the more difficult portions of the base text have annotations. These portions are determined using the text difficulty table 320.

In addition to the annotations for the base text, the customized text can also include substitute text for the base text. The substitute text can be a simplified form of the base text, phonetics for the base text, or some other alternative to the base text.

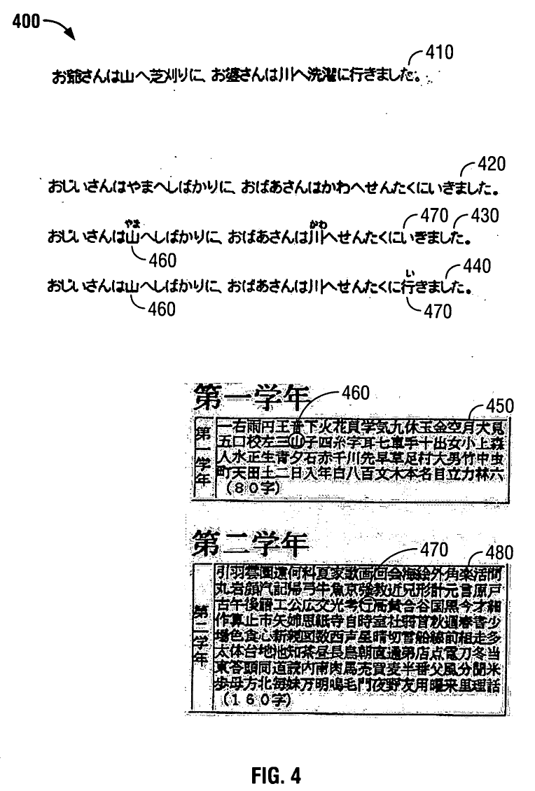

In one implementation, there are pre-defined reading levels and each reading level has a corresponding selection of annotations and substitutions to be displayed. The selection can be a selection of annotations, a selection of substitutions, or a selection that includes a mixture of annotations and substitutions. Readers can configure the selection to suit their own reading preferences. In one configuration, for a particular reading level, annotations are displayed only for characters that are difficult for that particular reading level. Characters that are much too difficult for the particular reading level are displayed with substitutions. This configuration is further illustrated in FIG. 4.

FIG. 4 shows a line of Japanese text 410 and three different presentations 420, 430, 440 of the text 410 customized for different reading levels. The first presentation 420 of the text 410 is for a beginner reader who is unable to recognize any kanji characters. In this presentation 420, all of the kanji in the text are replaced by substitute characters, for example, by kana.

The second presentation 430 of the text is for a level 1 reader. The level 1 character difficulty table 450 specifies kanji characters that are difficult for a level 1 reader. These characters can be, for example, the kanji characters that are typically learned during the first grade of school. The character difficulty table 450 specifies that the kanji character 460 is difficult for a level 1 reader. Thus, in the level 1 presentation 430 of the text, this kanji character 460 is displayed with furigana. In this presentation 430, characters of higher difficulty than level 1, for example, level 2 characters 470, are replaced by kana.

The third presentation 440 of the text is for a level 2 reader. A level 2 reader has already mastered the level 1 characters, thus, in the level 2 version 440 of the text, the level 1 characters 460 are displayed without furigana 490. Level 2 characters, for example, the character 470, are displayed with furigana. The text display mechanism 110 identifies level 2 characters using the level 2 character difficulty table 480. Characters of higher difficulty than level 2 are replaced by kana.

Min/Max Option

In one implementation, rather than specify a reading level, the user simply specifies a preference for either full annotations or no annotations. Similarly, the user can specify a preference for either full substitutions or no substitutions.

Web-Based Implementation

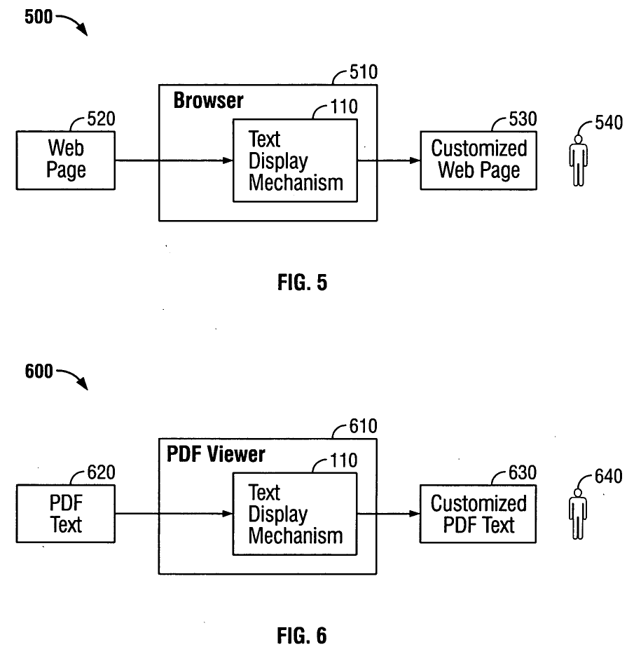

In one implementation 500, illustrated in FIG. 5, the text display mechanism 110 is part of a web browser 510 and the received text 120 is text 520 that is in HTML (Hypertext Markup Language) format. In this implementation, the web browser 510 receives a user request for a web page that includes the text 520. The web browser 510 retrieves the requested web page and passes the web page to the text display mechanism 110. The text display mechanism 110 customizes the text 520 using the customization techniques described above.

In one implementation, the text display mechanism 110 directly displays the selected annotations or substitutions without changing the text 520, for example, by superimposing the selected annotations or substitutions on top of the existing text 520.

Alternatively, the text display mechanism 110 changes or rebuilds the HTML markup to incorporate the selected annotations or substitutions as ruby text. Techniques for representing ruby text in HTML format are well known. For example, the World Wide Web Consortium (W3C) has developed a standard for defining markup for ruby. The W3C standard is published at: www.w3.org/TR/ruby/. The text display mechanism 110 then returns the web page with the customized text 530 to the web browser 510. The web browser 510 displays the web page for viewing by the reader.

PDF Implementation

In one implementation 600, illustrated in FIG. 6, the text display mechanism 110 is part of a PDF (portable document format) viewer 610 and the received text 120 is text 620 that is in PDFformat. In this implementation, the PDF viewer 610 receives a user request for a PDF document that includes the text 620. The PDF viewer 610 retrieves the requested text and passes the text to the text display mechanism 110. The text display mechanism 110 customizes the text 620 using the customization techniques described above. As described above for the web-based implementation, the text display mechanism 110 can display the selected annotations or substitutions with or without rebuilding the text 620.

The invention and all of the functional operations described in this specification can be implemented in digital electronic circuitry, or in computer software, firmware, or hardware, including the structural means disclosed in this specification and structural equivalents thereof, or in combinations of them. The invention can be implemented as one or more computer program products, i.e., one or more computer programs tangibly embodied in an information carrier, e.g., in a machine-readable storage device or in a propagated signal, for execution by, or to control the operation of, data processing apparatus, e.g., a programmable processor, a computer, or multiple computers. A computer program (also known as a program, software, software application, or code) can be written in any form of programming language, including compiled or interpreted languages, and it can be deployed in any form, including as a stand-alone program or as a module, component, subroutine, or other unit suitable for use in a computing environment. A computer program does not necessarily correspond to a file. A program can be stored in a portion of a file that holds other programs or data, in a single file dedicated to the program in question, or in multiple coordinated files (e.g., files that store one or more modules, sub-programs, or portions of code). A computer program can be deployed to be executed on one computer or on multiple computers at one site or distributed across multiple sites and interconnected by a communication network.

The processes and logic flows described herein, including the method steps of the invention, can be performed by one or more programmable processors executing one or more computer programs to perform functions of the invention by operating on input data and generating output. The processes and logic flows can also be performed by, and apparatus of the invention can be implemented as, special purpose logic circuitry, e.g., an FPGA (field programmable gate array) or an ASIC (application-specific integrated circuit).

Processors suitable for the execution of a computer program include, by way of example, both general and special purpose microprocessors, and any one or more processors of any kind of digital computer. Generally, a processor will receive instructions and data from a read-only memory or a random access memory or both. The essential elements of a computer are a processor for executing instructions and one or more memory devices for storing instructions and data. Generally, a computer will also include, or be operatively coupled to receive data from or transfer data to, or both, one or more mass storage devices for storing data, e.g., magnetic, magneto-optical disks, or optical disks. Information carriers suitable for embodying computer program instructions and data include all forms of non-volatile memory, including by way of example semiconductor memory devices, e.g., EPROM, EEPROM, and flash memory devices; magnetic disks, e.g., internal hard disks or removable disks; magneto-optical disks; and CD-ROM and DVD-ROM disks. The processor and the memory can be supplemented by, or incorporated in special purpose logic circuitry.

To provide for interaction with a reader, the invention can be implemented on a computer having a display device, e.g., a CRT (cathode ray tube) or LCD (liquid crystal display) monitor, for displaying information to the reader and a keyboard and a pointing device, e.g., a mouse or a trackball, by which the reader can provide input to the computer. Other kinds of devices can be used to provide for interaction with a reader as well; for example, feedback provided to the reader can be any form of sensory feedback, e.g., visual feedback, auditory feedback, or tactile feedback; and input from the reader can be received in any form, including acoustic, speech, or tactile input.

The computing system can include clients and servers. A client and server are generally remote from each other and typically interact through a communication network. The relationship of client and server arises by virtue of computer programs running on the respective computers and having a client-server relationship to each other.

The invention has been described in terms of particular implementations, but other implementations can be implemented and are within the scope of the following claims. For example, in addition to the Japanese language implementation described above, implementations involving other languages are also possible. In an English language implementation, for example, the customization techniques described above can be used to provide synonyms for British terminology to help the U.S. reader or to provide definitions for difficult or unusual words. In certain implementations, multitasking and parallel processing may be preferable. Other implementations are within the scope of the following claims.

What is claimed is:

1. A computer program product, tangibly embodied in an information carrier, for displaying text, the computer program product being operable to cause data processing apparatus to perform operations comprising:
receiving digital text data comprising base text and annotation text, the annotation text including one or more annotation text elements, the base text including one or more base text elements, the digital text data associating each annotation text element with a base text element;
receiving as input user information about a reader;
customizing digital text data according to the user information about the reader; and
displaying the customized digital text data.

2. The product of claim 1, wherein:
the user information includes a reading level;
customizing digital text data according to the user information about the reader includes using the reading level to determine for which base text elements to display annotation text elements; and
displaying the customized digital text data includes displaying annotation text elements as ruby text for a first group of base text elements, and not displaying annotation elements for a second group of base text elements.

3. The product of claim 2, wherein customizing digital text data according to the user information about the reader includes mapping the user's reading level to one of a plurality of character difficulty tables that group the base text elements according to their difficulty level, each character difficulty table corresponding to a particular reading level.

4. The product of claim 1, wherein:
the user information includes a reading level and a reading preference;
the received digital text data further includes substitute text elements for one or more of the base text elements;
customizing digital text data according to the user information about the reader includes using the reading level and the reading preference to determine for which base text elements to display annotation text elements and for which base text elements to display substitute text elements; and
displaying the customized digital text data includes displaying annotation text elements as ruby text for a first group of base text elements, not displaying annotation text elements for a second group of base text elements; and displaying substitute annotation text elements in place of the base text elements for a third group of base text elements.

5. The product of claim 1, wherein:
the user information includes a reading preference;
the annotation text elements include elements that indicate pronunciation of base text elements and elements that indicate meaning of base text elements; and
customizing digital text data for display according to the user information includes using the reading preference to determine whether to display the elements that indicate pronunciation or the elements that indicate meaning or both.

6. The product of claim 1, wherein the user information is received as part of a request from the reader requesting that the text be displayed.

7. The product of claim 1, wherein the user information is received from stored information about the reader.

8. The product of claim 1, wherein the digital text data is part of a web page or a PDF (portable document format) document.

9. The product of claim 8, wherein displaying the customized digital text data includes rebuilding the web page or PDF document.

10. The product of claim 8, wherein displaying the customized digital text data includes displaying the customized digital text data without rebuilding the web page or PDF document.

11. Apparatus comprising:
means for receiving digital text data comprising base text and annotation text, the annotation text including one or more annotation text elements, the base text including one or more base text elements, the digital text data associating each annotation text element with a base text element;
means for receiving as input user information about a reader;
means for customizing digital text data according to the user information about the reader; and
means for displaying the customized digital text data.

12. The apparatus of claim 11, wherein:
the user information includes a reading level;
the means for customizing digital text data according to the user information about the reader includes means for using the reading level to determine for which base text elements to display annotation text elements; and
the means for displaying the customized digital text data includes means for displaying annotation text elements as ruby text for a first group of base text elements, and not displaying annotation elements for a second group of base text elements.

13. The apparatus of claim 12, wherein the means for customizing digital text data according to the user information about the reader includes means for mapping the user's reading level to one of a plurality of character difficulty tables that group the base text elements according to their difficulty level, each character difficulty table corresponding to a particular reading level.

14. The apparatus of claim 11, wherein:
the user information includes a reading level and a reading preference;
the received digital text data further includes substitute text elements for one or more of the base text elements;
the means for customizing digital text data according to the user information about the reader includes means for using the reading level and the reading preference to determine for which base text elements to display annotation text elements and for which base text elements to display substitute text elements; and
the means for displaying the customized digital text data includes means for displaying annotation text elements as ruby text for a first group of base text elements, not displaying annotation text elements for a second group of base text elements; and displaying substitute annotation text elements in place of the base text elements for a third group of base text elements.

15. The apparatus of claim 11, wherein:
the user information includes a reading preference;
the annotation text elements include elements that indicate pronunciation of base text elements and elements that indicate meaning of base text elements; and
the means for customizing digital text data for display according to the user information includes means for using the reading preference to determine whether to display the elements that indicate pronunciation or the elements that indicate meaning or both.

16. The apparatus of claim 11, wherein the user information is received as part of a request from the reader requesting that the text be displayed.

17. The apparatus of claim 11, wherein the user information is received from stored information about the reader.

18. The apparatus of claim 11, wherein the digital text data is part of a web page or a PDF (portable document format) document.

19. The apparatus of claim 18, wherein the means for displaying the customized digital text data includes means for rebuilding the web page or PDF document.

20. The apparatus of claim 18, wherein the means for displaying the customized digital text data includes means for displaying the customized digital text data without rebuilding the web page or PDF document.

21. A method comprising:
receiving digital text data comprising base text and annotation text, the annotation text including one or more annotation text elements, the base text including one or more base text elements, the digital text data associating each annotation text element with a base text element;
receiving as input user information about a reader;
customizing digital text data according to the user information about the reader; and
displaying the customized digital text data.
